(19) United States
(12) Patent Application Publication
(10) Pub. No.: US 2020/0037423 A1
(43) Pub. Date: Jan. 30, 2020

(54) DIMMING CONTROL FOR LIGHTING SYSTEMS AND METHODS THEREOF

(71) Applicants: LUCIS TECHNOLOGIES (SHANGHAI) CO., LTD., Shanghai (CN); LUCIS TECHNOLOGIES HOLDINGS LIMITED, Grand Cayman (KY)

(72) Inventors: Qingbin MENG, Shanghai (CN); Lin ZHOU, Shanghai (CN)

(73) Assignees: LUCIS TECHNOLOGIES (SHANGHAI) CO., LTD., Shanghai (CN); LUCIS TECHNOLOGIES HOLDINGS LIMITED, Grand Cayman (KY)

(21) Appl. No.: 16/337,021

(22) PCT Filed: Sep. 27, 2016
(86) PCT No.: PCT/CN2016/100321

§ 371 Date: Mar. 27, 2019

(51) Int. Cl. H05B 41/392; H05B 33/08

(52) U.S. Cl. CPC H05B 41/3924; H05B 33/0845; H05B 41/3927

(57) ABSTRACT

A dimming switch system (130). The system (130) may include a dimming switch (520), a weak current module (510) and a strong current module (530). The weak current module (510) may receive at least one drive signal and control a state of the dimming switch (520) based on the drive signal. The strong current module (530) may be connected to the dimming switch (520) and at least one lighting device (140). The strong current module (530) may control brightness of the lighting device (140) connected thereto based on the state of the dimming switch (520). The dimming switch (520) may include a phase-cutting switch (610) and at least one omnidirectional conduction unit (620). When the omnidirectional conduction unit (620) works, the dimming switch (520) is omnidirectionally conductive.

### TECHNICAL FIELD

The present disclosure relates to a switch system, and in particular, to a dimming switch system with an omnidirectional conduction function.

### BACKGROUND

Among traditional lighting devices, incandescent lamps are widely used as a well-developed luminaire in various fields. Since the illumination principle of the incandescent lamp is to heat the filament, using its thermal radiation to emit light, the brightness of the light can be changed by changing its inputted power to achieve a dimming control purpose. However, in the field of energy-saving lamps, since the illumination principle of fluorescent lamps such as ordinary fluorescent lamps is different from the illumination principle of the incandescent lamps, the dimming control system applied to the incandescent lamps are not suitable for the fluorescent lamps. There are only two options for the fluorescent lamps, i.e., turning on or turning off the fluorescent lamps. After a series of dimmable and energy-saving lighting devices such as Light Emitting Diodes (LEDs) emerges, switches with a dimming control function are also developed in the field of energy-saving lighting devices. The dimming control function may use a control unit (e.g., a dimmer or a control panel) to change the brightness, color, etc., of the light, thereby reaching a certain degree of comfort. For example, it is often necessary to control and adjust the light in scenarios e.g., hotels, conference rooms, shopping malls. Except for the dimming control function, a plurality of commercially available smart switches also have some other functions, e.g., remote control, smart wake-up, etc. Many families do not change their lighting devices while replacing their old switches with the dimming switches. Some traditional energy-saving lighting devices do not support the dimming control operation of the smart switches, i.e., a phase-cutting operation in the dimming control operation, which may cause the lighting device to flicker, not to work properly or make noises, etc. Even if the dimming switch is adjusted to the maximum brightness, the switch would still perform phase-cutting for 1 millisecond to 2 milliseconds. Therefore, there is an urgent need for a dimming switch with a phase-cut dimming function and an omnidirectional conductive function, which makes it compatible with a conventional non-dimmable lighting device that is not replaced at the home.

### SUMMARY

According to one aspect of the present disclosure, a dimming control for lighting system may be provided. The system may include a dimming switch, a weak current module and a strong current module. The weak current module may receive at least one drive signal and control a state of the dimming switch based on the drive signal. The strong current module may be connected to the dimming switch and at least one lighting device. The strong current module may control brightness of the lighting device connected thereto based on the state of the dimming switch. The dimming switch may include a phase-cutting switch and at least one omnidirectional conduction unit. When the omnidirectional conduction unit works, the dimming switch may be omnidirectionally conductive.

According to another aspect of the present disclosure, a dimming method of a dimming switch may be provided. The method may include receiving control data of a lighting device and generating at least one drive signal based on the control data. The drive signal may be used to drive a weak current module. The weak current module may control the state of the dimming switch after receiving the drive signal. A strong current module connected to the dimming switch may control the brightness of the lighting device connected thereto based on the state of the dimming switch. The controlling the state of the dimming switch may include controlling a state of a phase-cutting switch and a state of at least one omnidirectional conduction unit, and controlling the dimming switch to be omnidirectionally conductive when the omnidirectional conduction unit works.

In some embodiments, the state of the dimming switch may include an omnidirectional conduction state, and the controlling the state of the dimming switch may include turning on the omnidirectional conduction unit.

In some embodiments, the controlling the state of the dimming switch may further include preventing use of the phase-cutting switch.

In some embodiments, the state of the dimming switch may include a non-omnidirectional conduction state, and the controlling the state of the dimming switch may include turning on the phase-cutting switch in the dimming switch.

In some embodiments, the controlling the state of the dimming switch may further include prevent use of the omnidirectional conduction unit in the dimming switch.

In some embodiments, the drive signal may be generated by a processing module based on dimming control data and zero-crossing detection data information.

In some embodiments, the processing module may include a data transmission module, a data processing module, a data storing module and a drive signal generation module.

In some embodiments, the dimming control data may include user input data and data inputted by a sensor.

In some embodiments, the user input data may include local input data and remote input data.

Some of the additional features of the present disclosure may be explained in the following description. Some of the additional features of the present disclosure will be apparent to those skilled in the art from a review of the following description and the accompanying drawings. The features of the present disclosure may be realized and attained by practice or use of various aspects of the methodologies, instrumentalities and combinations set forth in the detailed examples discussed below.

### BRIEF DESCRIPTION OF THE DRAWINGS

The drawings described herein are provided to provide a further understanding of the present disclosure and form a part of the present disclosure. The illustrative embodiments of the present disclosure and the description thereof are used to explain the present disclosure and do not constitute a limitation of the present disclosure.

FIG. 1 is a schematic diagram illustrating an exemplary intelligent dimming switch system according to some embodiments of the present disclosure.

FIG. 2 is a schematic diagram illustrating a user input device according to some embodiments of the present disclosure.

FIG. 3 is a schematic diagram illustrating an intelligent control system according to some embodiments of the present disclosure.

FIG. 4 is a schematic diagram illustrating a processing module according to some embodiments of the present disclosure.

FIG. 5 is a schematic diagram illustrating a dimming switch system according to some embodiments of the present disclosure.

FIG. 6 is a schematic diagram illustrating a dimming switch according to some embodiments of the present disclosure.

FIG. 7 is a schematic diagram illustrating a relationship between a drive signal of an omnidirectional conduction unit and voltage output of a strong current module according to some embodiments of the present disclosure.

FIG. 8 is a flowchart illustrating a process for selecting a dimming mode according to some embodiments of the present disclosure.

FIG. 9 is a flowchart illustrating a process for dimming according to some embodiments of the present disclosure.

FIG. 10 is a schematic diagram illustrating a circuit of a dimming switch system according to some embodiments of the present disclosure.

FIG. 11 is a schematic diagram illustrating a processing module according to some embodiments of the present disclosure.

FIG. 12 is a schematic diagram illustrating a circuit of a zero-crossing detection module according to some embodiments of the present disclosure.

FIG. 13 is a schematic diagram illustrating a circuit of a dimming switch system according to some embodiments of the present disclosure.

### DETAILED DESCRIPTION

As used in the present disclosure and the appended claims, the singular forms “a,” “an,” and “the” include the plural forms as well, unless the content clearly dictates otherwise. In general, the terms “comprise” and “include” merely specify the presence of stated steps and elements, but do not preclude the presence of one or more other steps and elements. The methods or devices may also include other steps or elements. The term “based on” refers to “based at least in part on.” The term “one embodiment” refers to “at least one embodiment,” and the term “another embodiment” refers to “at least one additional embodiment.” The relevant definitions of other terms will be given in the description below.

Although the present disclosure makes various references to certain modules in the system according to some embodiments of the present disclosure, any number of different modules may be used and implemented in a security system. These modules are merely illustrative, and different modules may be used for different aspects of the system and the method.

According to some embodiments of the present disclosure, flowcharts are used to illustrate the operations performed by the system. It is to be expressly understood that the above or the following operations are not necessarily implemented precisely in order. Conversely, the operations may be implemented in inverted order, or simultaneously. Moreover, one or more other operations may be added to the flowcharts, or one or more operations may be removed from the flowcharts.

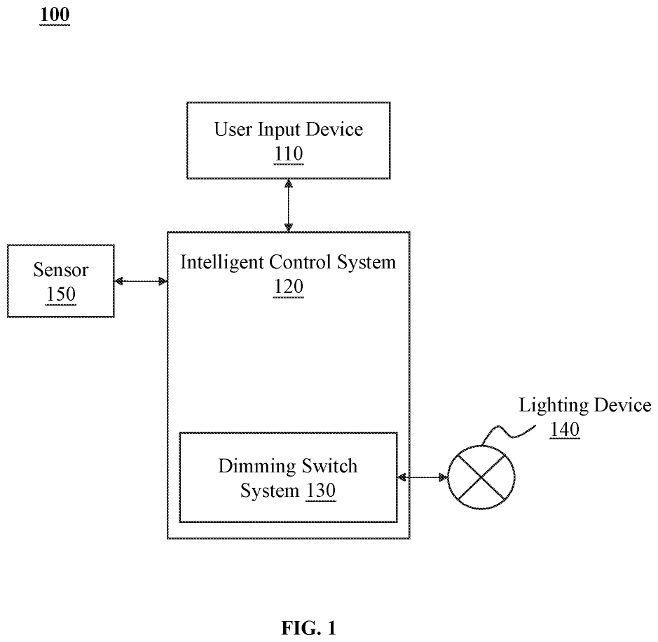

FIG. 1 is a schematic diagram illustrating an exemplary intelligent dimming switch system according to some embodiments of the present disclosure. The system 100 may include one or more user input devices 110, one or more sensors 150, one or more intelligent control systems 120, one or more lighting devices 140, and other components that may be used to implement the functions of the system 100. The intelligent control system 120 may include one or more dimming switch systems 130.

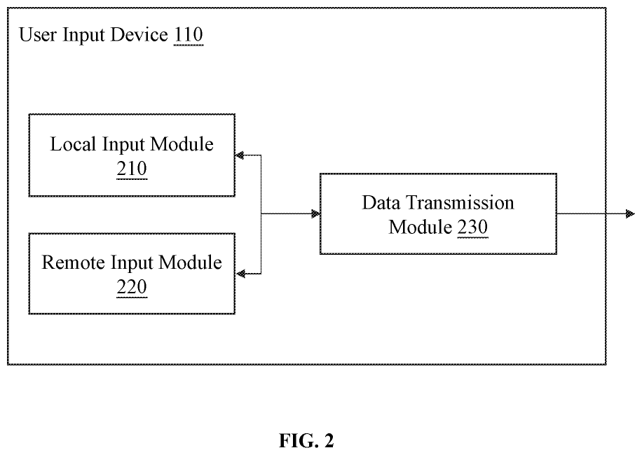

The user input device 110 may include one or more devices that may obtain, process, transmit (e.g., send, receive, etc.) user input. The user input may include, but is not limited to, local input and remote input. In some embodiments, the local input may be that a user performs data input directly on the device. The remote input may be that a user performs data input on a remote control terminal. The user input device 110 may include one or more local input devices and remote input devices. In some embodiments, the local input device may be an operation interface of a display screen. The remote input device may include, but is not limited to, a smartphone, a laptop computer, a tablet computer, and a remote controller. In some embodiments, the user input device 110 may include one or more modules as shown in FIG. 2.

As shown in FIG. 1, in some embodiments, the user input device 110 may include one or more devices that may obtain, process, transmit (e.g., send, receive, etc.) user input data. In some embodiments, the user input device 110 may be coupled/connected to the intelligent control system 120. The user input device 110 may transmit the user input data to the intelligent control system 120. The transmission mode may be wired or wireless. The connection between the user input device 110 and the intelligent control system 120 may be bidirectional. The user may observe feedback information given by the intelligent control system on an interface of the input device. The feedback information may include one or more of temperature data, brightness data of a lighting device, energy consumption data of the system, sound data, motion data, and other information that may be provided by the intelligent control system 120. In some embodiments, the user may set a specific time to turn on or turn off the lighting device via the user input device 110. A user may be also able to set a time period for the lighting device to be on or off with a certain brightness. In some embodiments, an input mode of the user input device 110 may include a keyboard input mode and a touch screen input mode. In some embodiments, a data input mode of the user input device 110 may include a direct input mode via the operation interface and a remote wireless input mode. When the user uses the remote wireless input mode, the user input device 110 may receive instruction information from the remote device of the user. In some embodiments, the user input device 110 may be an integrated chip or circuit.

The intelligent control system 120 may be a system that may analyze and process the received data and output control information. In some embodiments, the intelligent control system 120 may generate one or more control information. The control information may be based on the received sensor data and the user input data. In some embodiments, the control information may control the dimming switch system 130. In some embodiments, the intelligent control system 120 may adjust a working state of the lighting device 140 by controlling the dimming switch system 130. In some embodiments, the intelligent control system 120 may receive sensor data obtained from the sensor 150. The sensor data may include one or more of sound data, temperature data, humidity data, motion data, brightness data, and energy consumption data. In some embodiments, the intelligent control system 120 may receive the user input data from the user input device 110. In some embodiments, the connection mode between the intelligent control system 120 and a device may be wired or wireless. In some embodiments, the connection between the intelligent control system 120 and the device may be bidirectional. In some embodiments, the intelligent control system 120 may be an integrated chip or circuit, e.g., a processor, etc. In some embodiments, the intelligent control system 120 may include a plurality of sub-circuits.

The lighting device 140 may be any device that may convert electrical energy into light energy. In some embodiments, the lighting device 140 may include, but is not limited to, one or more of an LED lamp, a mercury lamp, a halogen lamp, a metal halide lamp, or an incandescent lamp, etc. In some embodiments, the lighting device 140 may include one or more lamps with dimming function and lamps without dimming function. The lamps with the dimming function may include, but are not limited to, an LED lamp, an incandescent lamp, a fluorescent lamp, a high-pressure and a low-pressure sodium lamp, a metal halide lamp, and a halogen lamp. The lamps without the dimming function may include, but are not limited to, a Compact Fluorescent Lamp (CFL) and a mercury lamp. In some embodiments, the working state of the lighting device 140 may be adjusted by the intelligent control system 120. The working state may include, but is not limited to, brightness, an “on” state an “off” state, a lighting duration, a flash frequency, or the like, or any combination thereof. In some embodiments, the adjustment of one or more working states of the lighting device may be controlled by the dimming switch system 130. In some embodiments, the brightness and other working states of the lighting device 140 may be adjusted by changing an input voltage of an electric light. Further, the changing the input voltage of the electric light may be implemented by a phase-modulated dimming technique. The phase-modulated dimming may include leading-edge phase control and trailing-edge phase control (also referred to as forward phase-cutting and backward phase-cutting).

The above description is only a specific embodiment of the present disclosure and should not be considered as the unique embodiment. Obviously, for those skilled in the art, various modifications and changes in form and detail may be made without departing from the principles and the structure of the present disclosure. For example, the sensor 150 may be included in the lighting device 140, the intelligent control system 120, and the user input device 110 so that these devices may simultaneously detect and send data or other data of the devices to the intelligent control system 120 when the devices work normally. For example, the dimming switch system 130 may be independent from the intelligent control system 120 and control the lighting device 140 independently. These modifications and changes may be still within the scope of the claims of the present disclosure.

FIG. 2 is a schematic diagram illustrating a user input device according to some embodiments of the present disclosure. The user input device 110 may include a local input module 210, a remote input module 220, and a data transmission module 230.

The local input module 210 may allow a user to input user data on an operator interface. The user data may be used to control and adjust a working state of the lighting device. In some embodiments, a data input mode of the local input module 210 may include a keyboard input mode and a touch screen input mode. In some embodiments, the local input module 210 may include a light sensor, a sound sensor, and a touch sensor. The light sensor, the sound sensor and the touch sensor may control brightness of a screen of an operation interface of the local input module according to detected surrounding environment data. It may be convenient for the user to operate the local input module 210 when the brightness is low at night.

The remote input module 220 may allow the user to input user data on the remote device and send the data to the data transmission module 230 via wireless communication. The remote device may be an electronic input device supporting communication such as a mobile phone, a tablet computer, a wearable device (glasses, a bracelet, a virtual reality helmet, etc.), a desktop computer, or a laptop computer. In some embodiments, the remote input module 220 may support the user to control the dimming switch on the remote client terminal via a network. For example, before entering the house, the user may turn on the switch and adjust the brightness of an indoor light through the mobile phone in advance to ensure that the user may walk safely when the brightness is low at night. In some embodiments, the remote input module 220 may also transmit remote sensor data. The sensor may include sensor devices involved in the local input module 210. For example, a light sensor may be placed at a certain position of a living area. The light sensor may detect an intensity change of the sunlight of the day in real-time to provide a suitable brightness control instruction to lighting devices in resident houses of the living area. For example, when the weather is cloudy or rainy and the sunlight is insufficient, the sensor may send a remote input instruction for enhancing the illumination to the lighting device in the houses.

The data transmission module 230 may transmit the received user input data to the intelligent control system. In some embodiments, the data transmission module 230 may include a wireless communication unit. The wireless communication unit may receive user data sent from the remote input module 220. In some embodiments, the data transmission module 230 may include a pre-processing unit. The pre-processing unit may preprocess the user input data and then transmit it to the intelligent control system 120 for further processing.

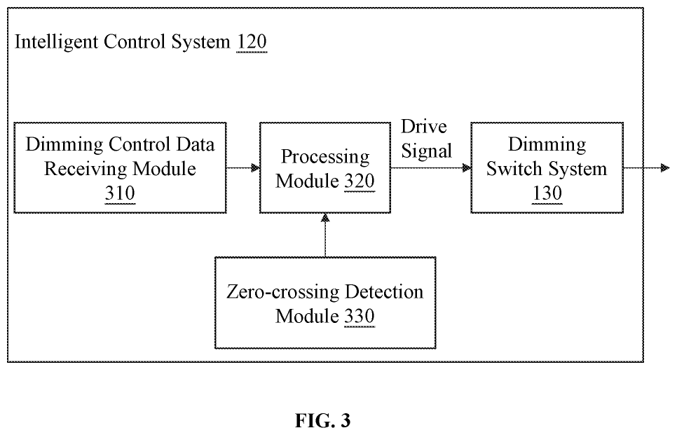

FIG. 3 is a schematic diagram illustrating an intelligent control system according to some embodiments of the present disclosure. The intelligent control system 120 may include a dimming control data receiving module 310, a processing module 320, a zero-crossing detection module 330, and a dimming switch system 130.

The dimming control data receiving module 310 may receive dimming control data. The dimming control data may include user input data from the user input device 110 and data collected from the sensor 150. Further, the dimming control data receiving module 310 may transmit the received dimming control data to the processing module 320.

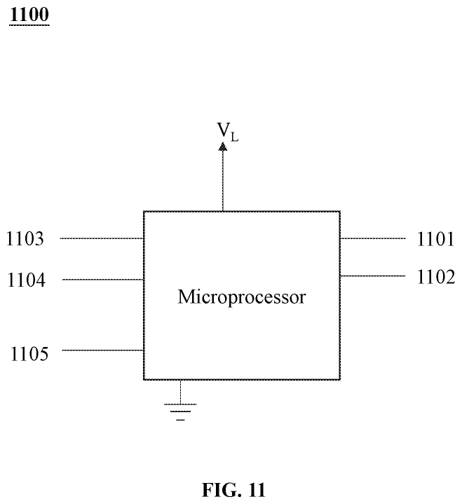

The processing module 320 may include one or more modules that may perform data processing based on the input data and output a processing result. In some embodiments, the processing module 320 may perform the data processing according to the received dimming control data and zero-crossing detection data, and output a drive signal according to the processing result. The dimming control data may be provided by the dimming control data receiving module 310. The zero-crossing detection data may be provided by the zero-crossing detection module 330. In some embodiments, the processing module 320 may analyze the received input data. In some embodiments, the processing module 320 may include one or more integrated chips or circuits, e.g., a processor, etc. For example, the processing module 320 may include one or more microprocessors as shown in FIG. 11. In some embodiments, the processing module 320 may include a plurality of sub-circuits.

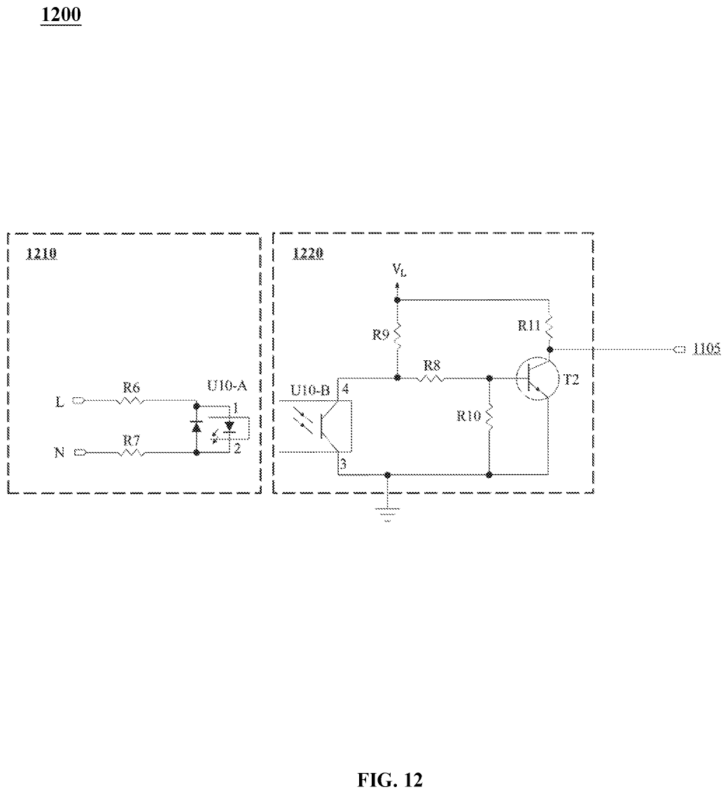

The zero-crossing detection module 330 may detect the zero crossing and a zero-crossing time when a waveform of an alternating current (AC) signal is converted from a positive half-cycle to a negative half-cycle in an alternating current system. In some embodiments, the zero-crossing detection module 330 may include one or more integrated circuits. In some embodiments, the zero-crossing detection module 330 may include an AC (alternating current) opto-isolated zero-crossing detection circuit. More specifically, the zero-crossing detection module 330 may include one or more circuits and sub-circuits thereof as shown in FIG. 12. In some embodiments, the zero-crossing detection module 330 may send the detected zero-crossing data information to the processing module 320 for further processing. In some embodiments, the zero-crossing detection module 330 may be independent from the intelligent control system 120 and implement the function of detecting the zero-crossing and sending data.

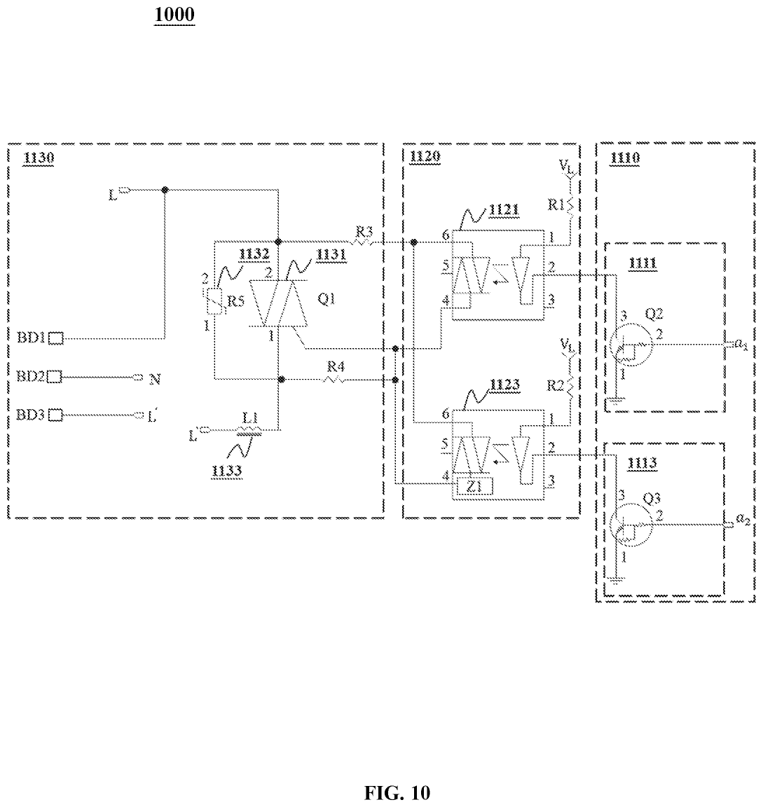

The dimming switch system 130 may be a system that may adjust the working state of the lighting device. The working state of the lighting device may include, but is not limited to, an “on” state, an “off” state, brightness, lighting duration, or a combination thereof. In some embodiments, the dimming switch system 130 may adjust the brightness of a lighting device with a dimming function. Different intensities of output lights may be obtained by controlling the input voltage. The changing of the input voltage may be achieved by a phase-modulated dimming technique. According to the brightness set by the user on the operation interface, the system may adjust a corresponding intensity of the output light. In some embodiments, the dimming switch system 130 may also control a switch of a lighting device without a dimming function. When the dimming switch system 130 controls to turn on the lighting device, the state of the dimming switch may be in the omnidirectional conduction state. In the meanwhile, the lighting device may reach the maximum brightness without generation of the phase-cutting. In some embodiments, the dimming switch system 130 may output a control result to the lighting device. The output light of the lighting device may reflect the result of the adjustment. In some embodiments, the dimming switch system 130 may include one or more circuits and sub-circuits thereof as shown in FIG. 10.

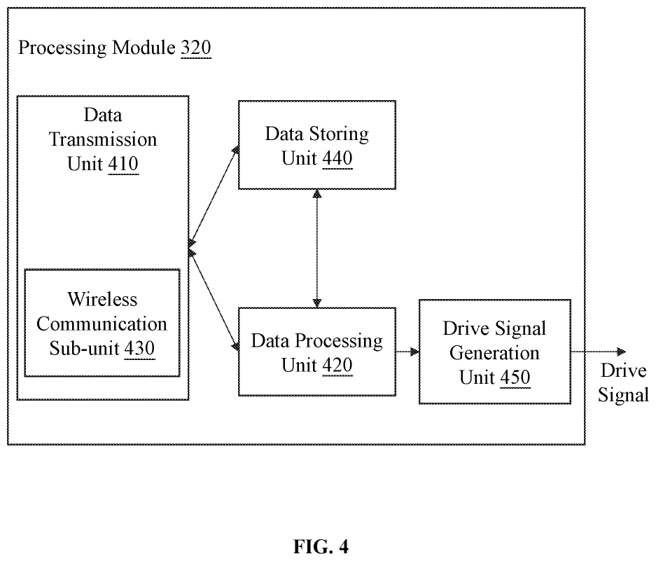

FIG. 4 is a schematic diagram illustrating a processing module according to some embodiments of the present disclosure. The processing module 320 may include a data transmission unit 410, a data processing unit 420, a data storing unit 440, and a drive signal generation unit 450. The data transmission unit 410 may include a communication sub-unit 430. In some embodiments, the processing module 320 may include one or more processing units connected to each other. The one or more processing units may communicate or connect with a portion of or all of the modules or devices in the system. More specifically, the processing module 320 may include one or more circuits and sub-circuits thereof as shown in FIG. 11.

The data transmission unit 410 may transmit received data to the data storing unit 440 and the data processing unit 420. In some embodiments, the data transmission unit 410 may include a wireless communication sub-unit 430. The wireless communication sub-unit 430 may receive wireless communication data sent by the remote device. The wireless communication data may include user input data from a remote client terminal and data sent by a remote sensor.

The data processing unit 420 may be a core control unit for data analysis processing. In some embodiments, the data processing unit 420 may be connected with other modules or units in the system. In some embodiments, the data processing unit 420 may analyze the data from the data transmission unit 410 and detect abnormal data thereof. In some embodiments, the data processing unit 420 may feedback the abnormal data to the intelligent control system 120. A device that may generate the abnormal data may be adjusted by the intelligent control system 120. In some embodiments, the data processing unit 420 may display the data information on the user operation interface. In some embodiments, the data processing unit 420 may generate one or more drive information. The drive information may be based on the data received by the data transmission unit 410. In some embodiments, the data processing unit 420 may include one or more processing units connected to each other. The one or more processing units may communicate or connect with a portion of or all modules or devices in the system.

The data storing unit 440 may be a unit that may store data information. The data information may include parameter information set by a user, parameter information of a switching mode, parameter information of a dimming mode, and parameter information of a system runtime. In some embodiments, the data storing unit 440 may cache temporary data of the system. In some embodiments, the data storing unit 440 may restore default settings of the system. The user may operate to restore the default settings and reset the various parameter information of the switch when the user wants to reinstall the dimming switch. In some embodiments, the data storing unit 440 may include one or more storages.

The drive signal generation unit 450 may be a unit that may convert the data processing result into an electrical drive signal. In some embodiments, the drive signal generation unit 450 may generate a corresponding drive signal based on the processing result of the data processing unit 420, and send it to the dimming switch system 130. In some embodiments, for the lighting device with the dimming function, the drive signal generation unit 450 may generate a first drive signal after the data processing. The first drive signal may drive the dimming switch system 130 to perform dimming control on the lighting device to adjust the brightness of the lighting device. In some embodiments, for the lighting device without the dimming function, the drive signal generating unit may generate a second drive signal after the data processing. The second drive signal may drive the dimming switch system 130 to perform switching control on the lighting device, and control to turn on or turn off the lighting device. In some embodiments, the drive signal generating unit may include one or more sub-circuits.

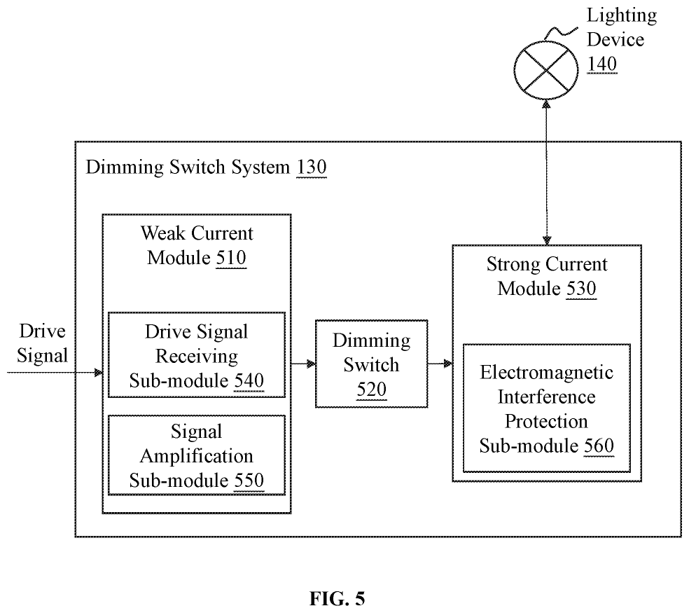

FIG. 5 is a schematic diagram illustrating a dimming switch system according to some embodiments of the present disclosure. The dimming switch system 130 may include a weak current module 510, a dimming switch 520, and a strong current module 530. The weak current module 510 may include a drive signal receiving sub-module 540 and a signal amplification sub-module 550. The strong current module may include an electromagnetic interference protection sub-module 560. More specifically, the dimming switch system 130 may include one or more circuits and sub-circuits thereof as shown in FIG. 10.

In the dimming switch system 130, the dimming switch 520 may be used as a connection point to connect the weak current module 510 and the strong current module 530. The weak current module 510 may be a control circuit. A power supply voltage of the control circuit may be far smaller than a power supply voltage of the lighting device circuit. For example, in some embodiments, the power supply voltage of the control circuit may be about 3.3V, 5V, 1.5V, or other suitable voltage values. The weak current module 510 may be used as a drive signal transmission circuit, receive a drive signal and transmit it to the dimming switch 520. The drive signal may include a drive signal generated by the drive signal generation unit 450 in the processing module 320, or may be a drive signal manually defined and applied by a user or other drive signals. For example, in some embodiments, when testing the working state of the dimming switch 520, different types of drive signals may be applied to the weak current module 510 to control the working state of the dimming switch. The types of the drive signals may be a continuous analog signal, or a discrete pulse signal, etc. The drive signal may be implemented by the drive signal receiving sub-module 540 in the weak current module 510. The drive signal receiving sub-module 540 may be a signal transmission circuit. The circuit may have an interface connected to the processing module 320. In some embodiments, an intensity of the drive signal transmitted from the processing module 320 to the weak current module 510 may be insufficient or the intensity of the drive signal may be partly lost after the circuit transmission, so the received drive signal may be amplified by a signal amplification sub-module 550. The signal amplification sub-module 550 may include one or more signal amplification circuits. The signal amplification circuit may include, but is not limited to, a voltage amplification circuit, a current amplification circuit, a power amplification circuit, or other similar signal amplification circuits. The type of the drive signal may be determined according to the type of the dimming switch 520. For example, in some embodiments, the dimming switch may perform phase-cutting dimming. The drive signal may be a pulse signal including information that a grid may cross a zero point. In some embodiments, the dimming switch may contain some zero-crossing detection circuits. The drive signal may be a high level signal that may maintain for a time period without including the information that the grid may cross the zero point.

The dimming switch 520 may be used as a connection node to connect the weak current module 510 and the strong current module 530. The dimming switch 520 may change an output power of the strong current module according to the information in the drive signal received by the weak current module 510, thereby changing the brightness of the lighting device connected to the strong current module. The technique for changing the output power of the strong current module may include a phase-cut dimming technique, an analog or digital dimming technique, a current-limiting dimming technique, an inductance ballast sub-power gear dimming technique, a variable resistance dimming technique, a pulse duty ratio dimming technique, a pulse frequency modulation dimming technique, a dimming technique by adjusting the supply voltage of a high frequency inverter, a pulse phase modulation dimming technique, a sine wave dimming technique, a dimming technique by changing a series inductance value, or the like, or a combination thereof. The power adjustment techniques may be implemented by the dimming switch 520. The dimming switch 520 may be a switch component, or a plurality of switch components, or a combination of a switch component and one or more circuit modules. The switch component in the dimming switch 520 may be isolated or non-isolated. For example, in some embodiments, the switch component in the dimming switch 520 may include a Tri-electrode Alternating Current Switch (TRIAC) driven by an opto-isolator. In some embodiments, the TRIAC may not include the opto-isolator, and the TRIAC may be directly driven by the weak current module through a drive circuit. In some embodiments, the dimming switch 520 may include a plurality of switch components. The plurality of switch components may be selectively turned on according to different drive signals. For example, if a switch component performs a phase-cutting operation, and another switch component performs an omnidirectional conduction operation, the drive signal may control to turn on the switch component with a phase-cutting operation function when a user chooses to adjust the brightness of the lighting device. When the user chooses to adjust the brightness of the lighting device to the maximum, the drive signal may control to turn on the switch component with the omnidirectional conduction function.

The strong current module 530 may be connected to an end of the grid to provide high voltage AC input. The strong current module may be connected to the lighting device 140. The output power of the strong current module may be controlled by the dimming switch 520. The brightness of the lighting device 140 may change according to the change of the output power of the strong current module 530. The strong current module 530 may include an electromagnetic interference protection sub-module 560. The electromagnetic interference protection sub-module 560 may reduce interference caused by electromagnetic waves and electronic components. The electromagnetic interference protection sub-module may be a series of circuits included in the strong current module.

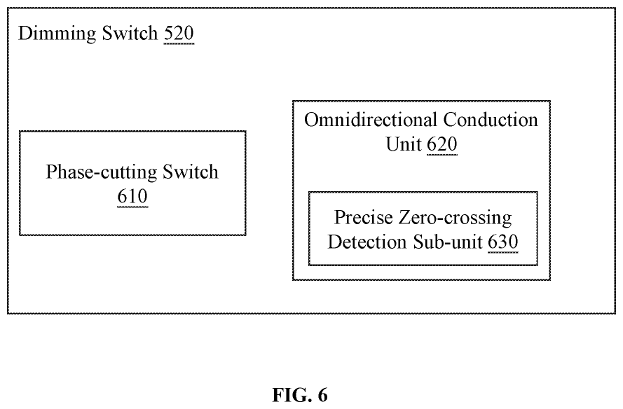

FIG. 6 is a schematic diagram illustrating a dimming switch according to some embodiments of the present disclosure. The dimming switch 520 may include a phase-cutting switch 610 and an omnidirectional conduction unit 620. The omnidirectional conduction unit 620 may also include a precise zero-crossing detection sub-unit 630.

In some embodiments, the phase-cutting switch 610 may be or include a TRIAC component. The phase-cutting switch 610 may perform a phase-cutting operation by controlling the output drive signal of the processing module 320 based on an opto-isolated drive mode. The phase-cutting operation may be used to adjust a triggering voltage of the TRIAC component, and change a time when the TRIAC component triggers to conduct. A portion of sinusoidal alternating current input in the strong current module 530 may be cut off, thereby reducing an energy obtained by the lighting device 140 connected to it, and the brightness may reduce. In the phase-cutting operation, since zero-crossing information of an alternating current of a grid may be needed, the drive signal that may drive the phase-cutting switch 610 may include the zero-crossing information of the grid. The zero-crossing detection module 330 may provide the zero-crossing information to the processing module 320. After the zero-crossing information is transmitted to the processing module 320, a time for performing the phase-cutting may be determined by software analysis. Time information of the time for performing the phase-cutting may be determined. The drive signal may be determined based on the time information and control a phase-cutting operation implemented by the phase-cutting switch 610 at any time.

In some embodiments, the zero-crossing information provided by the zero-crossing detection module 330 to the processing module 320 may have a certain deviation. A reason for the deviation may include an accuracy of the zero-crossing detection module 330 in detecting the zero crossing of the grid, or a fluctuation of a frequency of the grid, etc. In these embodiments, even in the maximum power, the phase-cutting operation may be usually performed within a short time period from a time before the zero crossing and a time after the zero crossing. For example, the short time period may be the phase-cutting for about 1 ms to 2 ms or other time periods. In the meanwhile, the phase-cutting switch 610 may be unable to implement the omnidirectional conduction function. If the zero-crossing point of the grid detected by the zero-crossing detection module 330 is accurate enough, or the frequency of the grid maintains stably, the phase-cutting switch 610 may be accurately controlled, thereby eliminating the phase-cutting at the maximum power and implementing the omnidirectional conduction.

In some embodiments, for example, when the phase-cutting switch 610 is unable to be omnidirectionally conductive or in other suitable conditions, the omnidirectional conduction function of the dimming switch 520 may be implemented by the omnidirectional conduction unit 620 in the dimming switch 520. The omnidirectional conduction unit 620 may be a circuit structure connected to the phase-cutting switch 610 or an omnidirectional conduction switch component connected to (e.g., in parallel) the phase-cutting switch 610. In some embodiments, the omnidirectional conduction unit may be a circuit structure applied to the phase-cutting switch 610. The circuit structure may be triggered when a user needs the omnidirectional conduction. The phase-cutting of the phase-cutting switch 610 may be eliminated for a short time period from a time before the zero crossing and a time after the zero crossing. In some embodiments, the omnidirectional conduction unit may include a phase-cutting switch with a precise zero-crossing detection sub-unit 630. The precise zero-crossing detection sub-unit 630 may be a zero-crossing trigger circuit for precisely detecting the zero-crossing point of the alternating current of the grid, so that the omnidirectional conduction unit 620 may be omnidirectionally conductive. The omnidirectional conduction unit 620 may also be driven by a drive signal. The drive signal may include or not include the zero-crossing detection information provided by the zero-crossing detection module 330. In some embodiments, the drive signal for driving the omnidirectional conduction unit 620 may include the zero-crossing detection information of the zero-crossing detection module 330, and then, the precise zero-crossing detection sub-unit 630 may re-check and verify the zero-crossing detection information to control the omnidirectional conduction unit 620 more precisely. In some embodiments, the drive signal for driving the omnidirectional conduction unit 620 may not include the zero-crossing detection information of the zero-crossing detection module 330. The omnidirectional conduction unit 620 may be controlled by the precise zero-crossing detection sub-unit 630. For example, in some embodiments, when the drive signal provides a driving current, the precise zero-crossing detection sub-unit 630 may turn on the phase-cutting switch in the omnidirectional conduction unit 620 at zero-crossing points of each half cycle. If the drive signal is a high level signal for a time period, the omnidirectional conduction unit 620 may always conduct during the time period, thereby implementing the omnidirectional conduction.

The phase-cutting switch 610 and the omnidirectional conduction unit 620 may be in a parallel relationship, i.e., the omnidirectional conduction unit 620 may be not triggered when the phase-cutting switch 610 is turned on, or the phase-cutting switch 610 may be not turned on when the omnidirectional conduction unit 620 is triggered. This switching relationship may be controlled by the drive signal from the processing module 320. For example, in some embodiments, when the user needs to adjust the brightness of the lighting device 140, the processing module 320 may send a drive signal that may control the phase-cutting switch 610. When the user does not need to adjust the brightness of the lighting device 140, or wants the maximum brightness, the processing module 320 may send a drive signal that may control the omnidirectional conduction unit 620.

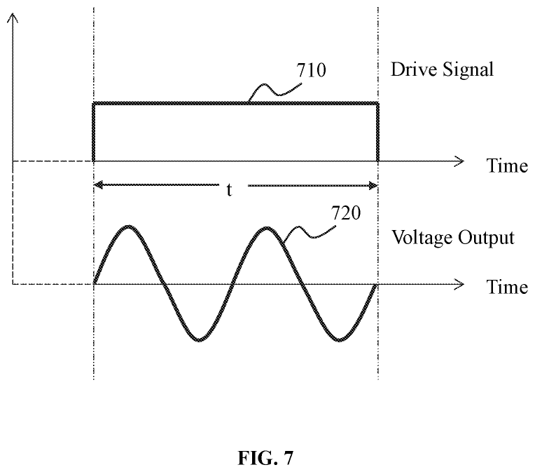

FIG. 7 is a schematic diagram illustrating a relationship between a drive signal of an omnidirectional conduction unit and voltage output of a strong current module according to some embodiments of the present disclosure. As shown in the figure, a drive signal 710 of the omnidirectional conduction unit 620 may be a high level signal that may maintain for a time period (e.g., a time period t of two cycles, a time period of several cycles, etc.). During the time period, voltage output 720 of the strong current module may be a sinusoidal curve in the two cycles. No phase-cutting operation may exist in this process, and the dimming switch 520 may be omnidirectionally conductive.

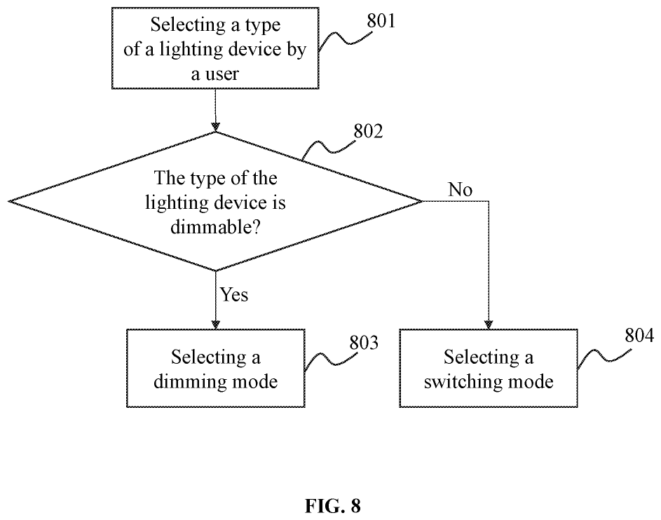

FIG. 8 is a flowchart illustrating a process for selecting a dimming mode according to some embodiments of the present disclosure. In the present disclosure, the dimming switch system 130 may have a phase-cutting function and an omnidirectional conduction function. The entire switch system may be selected as a dimming mode and a switching mode. The dimming mode may change an output power of the strong current module 530 according to user requirements, and change brightness of the lighting device 140. The switching mode may be triggering the omnidirectional conduction unit 620 and prevent using the phase-cutting switch 610 to implement an omnidirectional conduction of the switch. The dimming mode may be used in some dimmable lighting devices (e.g., LED lighting devices, etc.). The switching mode may be used in some lighting devices that are not suitable for dimming (e.g., Compact Fluorescent Lamps (CFL) lighting devices, etc.).

In step 801, a user may select a type of a lighting device. The selection may be performed on an indoor operation device, or may be done by a remote operation device, e.g., a mobile phone, etc. In some embodiments, the selection may be implemented by the user input device 110. In some embodiments, when installing the switch of the present disclosure for a first time, the user may select the type of the lighting device connected to the switch on a user interface of a corresponding operation device. The user may also select the type of the lighting device by a remote operation device e.g., a mobile phone, etc. The user may manually select whether the connected lighting device is a dimmable or a non-dimmable lighting device, or directly input a model or ID information of the lighting device. The data storage module 440 of the switch may store information of most of commercially available lighting. The information of the lighting device may include a manufacturer, a production batch, a device specification, etc. The device specification may include information whether the lighting device may be dimmed.

In step 802, the processing module 320 may analyze the lighting device selected by the user and determine whether the lighting device 140 connected with the switch may have a dimming function. If the user directly inputs information whether the lighting device 140 may be dimmable, the determination may be made directly in the determination step. If the user inputs the information, e.g., the model of the lighting device, in this step, the processing module 320 may compare the user input data with device information stored in the data storage module 440, and retrieve the user input data in the stored information, and whether the lighting device input by the user may be dimmable may be determined based on the dimming information included in the search result. If the type of the lighting device is dimmable, the switch may be configured as the dimming mode, otherwise it may be configured as the switching mode.

In some embodiments, the processing module 320 may determine that the type of the lighting device selected by the user may be dimmable. In step 803, the processing module 320 may select a dimming mode to control the lighting device. For example, the processing module 320 may turn on the phase-cutting switch 610 in the dimming switch 520. A power of the lighting device may be adjusted through a phase-cutting operation of the phase-cutting switch 610 when the user needs to adjust brightness of the lighting device. In the dimming mode, when the user needs to adjust the brightness of the lighting device to a maximum, the omnidirectional conduction unit 620 may be turned on and the phase-cutting switch 610 may be turned off. In the meanwhile, the power obtained by the lighting device may reach the maximum, i.e. the maximum brightness.

In some embodiments, in step 802, the processing module 320 may determine that the type of lighting device selected by the user may be not dimmable. In these embodiments, in step 804, the processing module may select the switching mode (i.e., a non-dimmable mode) to control the lighting device. For example, the phase-cutting switch 610 in the dimming switch 520 may be turned off and the omnidirectional conduction unit 620 may be turned on to implement the switching mode. In this mode, the dimming switch 520 may be omnidirectionally conductive. The lighting device connected to the switch may work at a stable power.

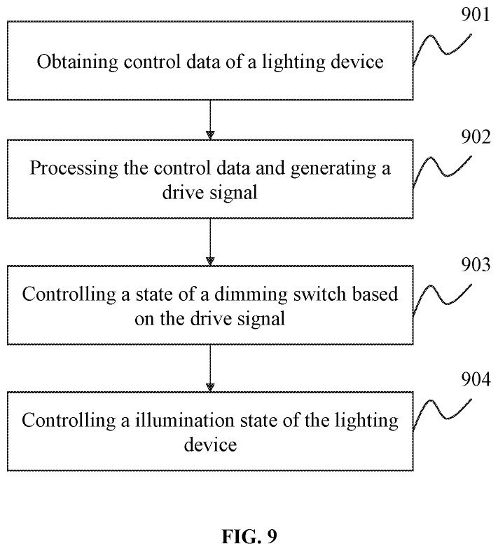

FIG. 9 is a flowchart illustrating a process for dimming according to some embodiments of the present disclosure. The flowchart may describe a basic process from receiving control data of the lighting device from the entire switch system to changing the illumination state of the lighting device. In step 901, the intelligent control system 120 may obtain the control data of the lighting device. The control data may be data of controlling whether the lighting device is on or off, or may be data that may control the brightness of the lighting device. The type of the data may be associated with the selected working mode of the switch. For example, when the switch is in the dimming mode, the control data may include information that the lighting device may be on or off, and may also include information that may control its brightness. In the switching mode, the control data may include information that the lighting device may be on or off. The control data may be from the user input device 110 or may be from the sensor 150 or other devices. For example, in some embodiments, the user inputs data through the operation interface of the switch system or inputs data through a remote input device e.g., a mobile phone, etc. In some embodiments, the sensor may sense environmental parameters and generate the control data of the lighting device according to the environmental parameters. For example, when an ambient brightness is high, the control data of the lighting device may be a control instruction for reducing the brightness of the lighting device. The environmental parameters may include parameters such as brightness, temperature, humidity, or the like.

In step 902, the processing module 320 may process the obtained control data of the lighting device. The drive signal generation unit 450 may generate a drive signal that may control the dimming switch 520. The process for processing the control data may include a signal conversion process, e.g., amplitude information of brightness adjustment of the lighting device input by the user may be converted to control data of controlling the phase-cutting switch 610, etc. The generated drive signal may be determined based on a type of the lighting device selected by the user, i.e., a working mode of an intelligent control system. For example, in some embodiments, if the intelligent control system selected by the user works in the dimming mode, the drive signal generated by the drive signal generation unit 450 may be used to control the phase-cutting switch 610, or may be used to control the omnidirectional conduction unit 620 when the user selects the maximum power output. In some embodiments, if the intelligent control system selected by the user works at the switching mode, the drive signal generated by the drive signal generation unit 450 may be only used to control the omnidirectional conduction unit 620.

In step 903, the dimming switch system 130 may control the state of the dimming switch based on the drive signal. When the drive signal is the drive signal driving the phase-cutting switch 610, the phase-cutting switch 610 may be controlled to perform a phase-cutting operation according to the user requirement for the brightness of the lighting device. When the drive signal is the drive signal controlling the omnidirectional conduction unit 620, the dimming switch 520 may be controlled to be omnidirectionally conductive.

In step 904, the intelligent control system 120 may control the illumination of the lighting device according to the state of the dimming switch 520. For example, when the phase-cutting switch 610 is turned on and a phase-cutting operation is performed, the lighting device may be controlled to work in a low-power state. When the omnidirectional conduction unit 620 is triggered, the lighting device may be controlled to work in the maximum power state.

FIG. 10 is a schematic diagram illustrating a circuit of a dimming switch system according to some embodiments of the present disclosure. As shown in the figure, the dimming switch system 1000 may include a weak current module 1110, a dimming switch 1120, and a strong current module 1130. The weak current module 1110 may include one or more signal amplification circuits, such as signal amplification circuits 1111 and 1113.

The dimming switch 1120 may include a phase-cutting switch 1121, an omnidirectional conduction unit 1123, and other electronic components. The phase-cutting switch 1121 may be an opto-isolator and may be controlled by the weak current module. After receiving a drive signal α₁ of the weak current module, a LED on a side of the weak current may emit light signals with different intensities according to the drive signal. A TRIAC on a side of the strong current may control the phase-cutting switch 1121 according to a received optical signal of the LED. The omnidirectional conduction unit 1123 may also be an opto-isolator with a structure similar to the 1121 and be controlled by a drive signal α₂. The TRIAC of the omnidirectional conduction unit 1123 may also be connected to a precise zero-crossing detection circuit Z1, which may be used to assist the switch to implement the omnidirectional conduction function.

The strong current module 1130 may include a tri-electrode alternating current switch 1131, an overvoltage protection device 1132 and a current spike suppression device 1133. The tri-electrode alternating current switch 1131 may be used as a main switching device of the dimming system, and may be controlled by the phase-cutting switch 1121 and/or the omnidirectional conduction unit 1123. The overvoltage protection device 1132 may be used to absorb a transient surge when the grid and/or the tri-electrode alternating current switch 1131 are turned off. The current spike suppression device 1133 may be used to suppress current spikes generated when certain capacitive lamps (such as LEDs) are charged when the phase-cutting is triggered.

In some embodiments, the signal amplification circuit 1111 may receive and amplify the drive signal α₁ to generate a first amplified drive signal. Similarly, the signal amplification circuit 1111 may receive and amplify the drive signal α₂ to generate a second amplified drive signal. In some embodiments, the first amplified drive signal and the second amplified drive signal may be used to control the phase-cutting switch 1121 and the omnidirectional conduction unit 1123, respectively.

FIG. 11 is a schematic diagram illustrating a processing module according to some embodiments of the present disclosure. In this embodiment, the processing module may include a microprocessor 1100. 1101 and 1102 may be received control data for the lighting device, which may be user input data or data inputted by a sensor. 1103 and 1104 may be drive signals of the phase-cutting switch and the omnidirectional conduction unit, respectively. 1105 may be a zero-crossing signal provided to the microprocessor by the zero-crossing detection module. V_{L} may be power input to the microprocessor. The microprocessor 1100 may include one or more Programmable Interrupt Controllers (PIC), single-chip microcomputers (e.g., STM8, STM32, Cortex A), Digital Signal Processing (DSP) chips and other processors that may be used to implement the processing module.

FIG. 12 is a schematic diagram illustrating a circuit of a zero-crossing detection module according to some embodiments of the present disclosure. The zero-crossing detection circuit 1200 may be divided into a strong current side 1210 and a weak current side 1220 by an opto-isolator. A signal 1105 with zero-crossing information may be generated based on a frequency of grids on the strong current side, and transmitted to the microprocessor.

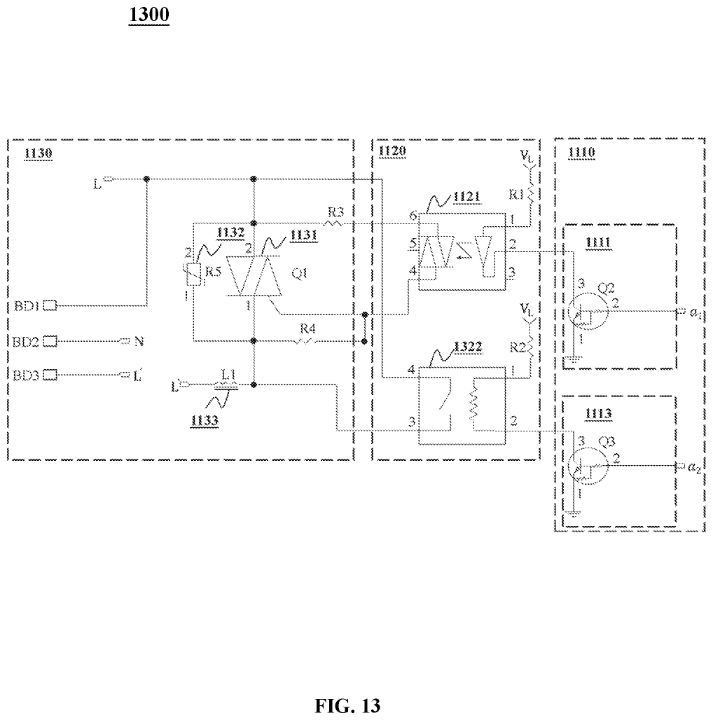

FIG. 13 is a schematic diagram of a circuit of a dimming switch system according to some embodiments of the present disclosure. Different from the embodiment shown in FIG. 11, this embodiment may replace the opto-isolator with a relay 1322. The relay 1322 may be still connected to the weak current module 1110 and the strong current module 1130, and controlled by the drive signal α₂. When a certain maintenance current flows through a coil of the weak current side of the relay, the switch of the strong current side may be controlled to be closed. Since the relay 1322 may not include a tri-electrode alternating current switch structure, it may not need to perform phase-cutting at a zero-crossing point, but omnidirectional conduction may be maintained when the switch on the strong current side is closed. The drive signal α₂ may also include zero-crossing information to assist in controlling the relay 1322. For example, when the switch of the relay 1322 on the strong current side closes or opens near the zero-crossing point, the influence of surge voltages and peak currents at both ends of the switch on the system may be avoided when the switch closes or opens. The drive signal α₂ may be as close as possible at the zero-crossing point when the switch of the relay 1322 on the strong current side is controlled to close or open.

Having thus described the basic concept, it is rather apparent to those skilled in the art that the disclosure is intended to be presented by way of example only and is not limiting. Various modifications, improvements, and alterations of the present disclosure may be made by those skilled in the art, though not expressly stated herein. These alterations, improvements, and modifications are intended to be suggested by this disclosure, and are within the spirit and scope of the exemplary embodiments of this disclosure.

Moreover, certain terminology has been used to describe embodiments of the present disclosure. For example, the terms “one embodiment,” “an embodiment,” and/or “some embodiments” mean that a particular feature, structure or characteristic described in connection with the embodiment is included in at least one embodiment of the present disclosure. Therefore, it is emphasized and should be appreciated that two or more references to “an embodiment” or “one embodiment” or “an alternative embodiment” in various parts of this specification are not necessarily all referring to the same embodiment. Furthermore, the particular features, structures, or characteristics may be combined as suitable in one or more embodiments of the present disclosure.

Further, those skilled in the art will appreciate that aspects of the present disclosure may be illustrated and described herein in any of a number of patentable classes or context, including any new and useful process, machine, manufacture, or combination of matter, or any new and useful improvements thereof. Accordingly, aspects of the present disclosure may be implemented entirely hardware, entirely software (including firmware, resident software, micro-code, etc.) or combining hardware and software implementation that may all generally be referred to herein as a “data block,” “module,” “engine,” “unit,” “component” or “system”. Furthermore, aspects of the present disclosure may take the form of a computer product embodied in one or more computer readable media having computer readable program code embodied thereon.

Computer program code for carrying out operations for aspects of the present disclosure may be written in any combination of one or more programming languages, including an object oriented programming language such as Java, Scala, Smalltalk, Eiffel, JADE, Emerald, C++, C #, VB. NET, Python, or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Furthermore, the recited order of processing elements or sequences, or the use of numbers, letters, or other designations therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose, and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software only solution, e.g., an installation on an existing server or mobile device.

Similarly, it should be noted that in the foregoing description of embodiments of the present disclosure, various features are sometimes grouped together in a single embodiment, figure, or description thereof for the purpose of streamlining the disclosure aiding in the understanding of one or more of the various inventive embodiments. This method of disclosure, however, is not to be interpreted as reflecting an intention that the claimed subject matter requires more features than the features mentioned in the claims. Rather, inventive embodiments lie in less than all features of a single foregoing disclosed embodiment.

In some embodiments, the numbers expressing quantities of ingredients, properties, and so forth, used to describe and claim certain embodiments of the application are to be understood as being modified in some instances by the term “about,” “approximate,” or “substantially”. Unless otherwise stated, “about,” “approximate,” or “substantially” may indicate ±20% variation of the value it describes. Accordingly, in some embodiments, the numerical parameters set forth in the description and attached claims are approximations that may vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the application are approximations, the numerical values set forth in the specific examples are reported as precisely as practicable.

Each of the patents, patent applications, publications of patent applications and other materials, such as articles, books, specifications, publications, documents, articles, and/or the like, referenced herein is hereby incorporated herein by this reference in its entirety for all purpose, excepting any of same that is inconsistent with or in conflict with the present document, or any of same that may have a limiting affect as to the broadest scope of the claims now or later associated with the present document. It is to be noted that if there be any inconsistency or conflict between the description, definition, and/or the use of a term associated with any of the incorporated material and that associated with the present document, the description, definition and/or the use of the term in the present document shall prevail.

In closing, it should be understood that the embodiments of the application disclosed herein are merely illustrative of the principles of the embodiments of the present application. Other modifications that may be employed may be within the scope of the application. Thus, by way of example, but not of limitation, alternative configurations of the embodiments of the application may be utilized in accordance with the teachings herein. Accordingly, embodiments of the present disclosure are not limited to that precisely as shown and described.

We claim:

1. A dimming control for lighting system, comprising:
a dimming switch;
a weak current module controlling a state of the dimming switch based on at least one drive signal; and
a strong current module controlling brightness of a lighting device connected thereto based on the state of the dimming switch, wherein
the dimming switch includes a phase-cutting switch and at least one omnidirectional conduction unit; and
the dimming switch is omnidirectionally conductive when the omnidirectional conduction unit works.

2. The dimming control for lighting system of claim 1, wherein the state of the dimming switch includes an omnidirectional conduction state, and the controlling the state of the dimming switch includes turning on the omnidirectional conduction unit.

3. The dimming control for lighting system of claim 2, wherein the controlling the state of the dimming switch further includes preventing use of the phase-cutting switch.

4. The dimming control for lighting system of claim 1, wherein the state of the dimming switch includes a non-omnidirectional conduction state, and the controlling the state of the dimming switch includes turning on the phase-cutting switch.

5. The dimming control for lighting system of claim 4, wherein the controlling the state of the dimming switch further includes preventing use of the omnidirectional conduction unit.

6. The dimming control for lighting system of claim 1, wherein the drive signal is generated by a processing module based on dimming control data and zero-crossing detection data information.

7. The dimming control for lighting system of claim 6, wherein the processing module includes a data transmission module, a data processing module, a data storing module and a drive signal generation module.

8. The dimming control for lighting system of claim 6, wherein the dimming control data includes user input data and data inputted by a sensor.

9. The dimming control for lighting system of claim 8, wherein the user input data includes local input data and remote input data.

10. A dimming method of a dimming switch, comprising:
receiving control data of a lighting device;
generating at least one drive signal to drive a weak current module based on the control data of the lighting device;
controlling, by the weak current module, a state of the dimming switch based on the drive signal; and
controlling, by a strong current module connected to the dimming switch, brightness of the lighting device connected to the strong current module based on the state of the dimming switch, wherein
the controlling the state of the dimming switch includes controlling a state of a phase-cutting switch and a state of at least one omnidirectional conduction unit; and
controlling the dimming switch to be omnidirectionally conductive when the omnidirectional conduction unit works.

11. The dimming method of the dimming switch of claim 10, wherein the state of the dimming switch includes an omnidirectional conduction state, and the controlling the state of the dimming switch includes turning on the omnidirectional conduction unit.

12. The dimming method of the dimming switch of claim 11, wherein the controlling the state of the dimming switch further includes preventing use of the phase-cutting switch in the dimming switch.

13. The dimming method of the dimming switch of claim 10, wherein the state of the dimming switch includes a non-omnidirectional conduction state, and the controlling the state of the dimming switch includes turning on the phase-cutting switch.

14. The dimming method of the dimming switch of claim 10, wherein the controlling the state of the dimming switch further includes preventing use of the omnidirectional conduction unit in the dimming switch.

15. The dimming method of the dimming switch of claim 10, wherein the drive signal is generated by a processing module based on dimming control data and zero-crossing detection data information.

16. The dimming method of the dimming switch of claim 15, wherein the processing module includes a data transmission module, a data processing module, a data storing module and a drive signal generation module.

17. The dimming method of the dimming switch of claim 15, wherein the dimming control data includes user input data and data inputted by a sensor.

18. The dimming method of the dimming switch of claim 17, wherein the user input data includes local input data and remote input data.
